(19) United States
(12) Patent Application Publication
(10) Pub. No.: US 2013/0280148 A1
(43) Pub. Date: Oct. 24, 2013

(54) TUBE BUNDLE REACTOR HAVING A STRUCTURED PACKING

(71) Applicants: Frank Castillo-Welter, Friedrichsdorf (DE); Dominic Walter, Darmstadt (DE); Christoph Steden, Oberursel (DE); Rudolf Zeyen, Frankfurt am Main (DE)

(72) Inventors: Frank Castillo-Welter, Friedrichsdorf (DE); Dominic Walter, Darmstadt (DE); Christoph Steden, Oberursel (DE); Rudolf Zeyen, Frankfurt am Main (DE)

(73) Assignee: LURGI GMBH, Frankfurt am Main (DE)

(21) Appl. No.: 13/977,062

(22) PCT Filed: Dec. 9, 2011
(86) PCT No.: PCT/EP2011/006198

§ 371 Date: Jun. 28, 2013

(30) Foreign Application Priority Data
Feb. 21, 2011 (DE) 10 2011 011 895.0

(51) Int. Cl. B01J 8/06

(52) U.S. Cl. CPC B01J 8/067
USPC 422/652; 29/890.031

(57) ABSTRACT

A tubular reactor for carrying out a catalytically supported, homogeneous chemical reaction in the gas phase at an elevated temperature and a subsequent cooling, wherein the reactor is arranged upright, and therefore the tubes extend vertically and the as flows downward through the tubes. The tubes are filled with a catalyst bed in the upper part thereof extending in the reaction zone of the reactor and are filled with a structured packing in the lower part, the cooling zone of the reactor.

### CROSS-REFERENCE TO RELATED APPLICATIONS

This application is a U.S. national phase application under 35 U.S.C. §371 of International Application PCT/EP2011/006198, filed on Dec. 9, 2011, and claims benefit to German Patent Application No. 10 2011 011 895.0, filed on Feb. 21, 2011. The international application was published in German on Aug. 30, 2012, as WO 2012/113427 A1 under PCT Article 21(2).

### FIELD

This invention relates to a tubular reactor for carrying out a heterogeneously catalyzed chemical reaction in the gas phase at elevated temperature and with subsequent cooling of the gas phase, wherein the reactor is arranged upright, so that the tubes extend vertically from the upper gas distributor space, through the shell space, to the lower gas collecting space. The shell space is divided into a reaction and a cooling zone. In the region of the reaction zone, the tubes are filled with a bed of catalyst material. In the region of the cooling zone, the tubes are filled with inert material.

### BACKGROUND

Tube bundle reactors belong to the category of tubular reactors which are described in principle in Ullmann's Encyclopedia of Industrial Chemistry, Vol. 37, 6th Edition. Tubular reactors are particularly suitable for carrying out homogeneous reactions in the gas phase at elevated temperature.

The patent specification DE 30 42 468 C2 especially deals with tube bundle reactors. The same are constructed like tube bundle heat exchangers, wherein the gas phase flows through the tubes each filled with a catalyst bed and liquid heat-transfer medium circulates in the reactor shell. The reactor also can be divided into a reaction and a cooling zone, in that the shell region is divided into two zones by a partition through which the tubes are guided. It is possible that the zones each are equipped with a separate heat transfer circuit, or that they are traversed one after the other by a heat transfer medium.

In the region of the reaction zone, the tubes are filled with a catalyst bed and in the region of the cooling zone with an inert solid bed. The inert solid bed has the function to improve the heat transfer between gas and tube wall.

It is also possible that the reaction zone is divided into several sections, in each of which different catalyst material is used and which also can each be equipped with a separately temperable heat transfer circuit.

In operation of the reactor, it now can occur that beside the intended heterogeneously catalyzed reaction side reactions take place, which lead to the formation of liquid or solid by-products. These by-products preferable are condensed in the solid bed of the cooling zone, whereby the gas permeability is impaired and cleaning becomes necessary.

A possible method for cleaning the solid bed consists in thermally decomposing the deposited by-products. During the necessary heating of the solid bed of the cooling zone, however, a high thermal stress and hence a damage of the catalyst in the reaction zone often cannot be avoided. In order to save the catalyst, it then only is possible to remove the soiled solid bed from the tubes and replace it by a new or cleaned solid bed. Since this is not possible in normal operation of the reactor, considerable shut-down periods are caused thereby. Furthermore, there is a considerable expenditure of work for draining and newly filling the reaction tubes. This is true in particular for tubular reactors, in which many reactor tubes are arranged in parallel.

Especially in large reactors, the so-called tube bundle reactors, which can comprise up to several thousand tubes, the tubes often are arranged vertically. In this arrangement, the tubes easily can be filled with the inert and the catalyst material from above. Since filling of the tubes with loose material is not possible from below, the entire tube content, i.e. also the catalyst material, initially must be discharged from the bottom of the tubes, in order to replace the inert material present in the lower part of the tubes, and the tubes subsequently must again be filled from above.

When discharging the material from the tubes, catalyst and inert material or the various catalyst grades, which no longer can be separated in an economic way, mostly are mixed, so that a lot of catalyst material gets lost.

### SUMMARY

In an embodiment, the present invention provides a tubular reactor for carrying out a heterogeneously catalyzed gas phase reaction. The tubular reactor includes: a plurality of reactor tubes including a reaction zone and a cooling zone, wherein the reactor tubes are arranged vertically upright. The tubular reactor is configured such that a gaseous reaction mixture flows through the reactor tubes from top to bottom and, in doing so, passes first through the reaction zone and then through the cooling zone. In an upper part of the reactor tubes, extending in a reaction zone of the tubular reactor, the reactor tubes are filled with a catalyst bed of solid, granular catalyst. In a lower part of the reactor tubes, corresponding to the cooling zone of the reactor, the reactor tubes are filled with a structured packing. The catalyst bed and the structured packing each are held in their position by a gas-permeable, removable holder. The reactor tubes are heated in endothermic reactions, and cooled in exothermic reactions, by indirect heat exchange with a heat-transfer medium in the reaction zone, and are cooled in the cooling zone of the reactor.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 of the drawing shows an exemplary schematic diagram of a tubular reactor according to the invention.

FIG. 2 of the drawing by way of example shows a structure of the packing of a reactor tube according to the invention.

### DETAILED DESCRIPTION

An aspect of the invention is to provide a tube bundle reactor in which the cleaning of the cooling zone can be effected with less expenditure of work and with low losses of catalyst material.

In an embodiment of the invention, in the region of the cooling zone of the tubular reactor the loose inert material of the solid bed in the tubes, which forms a packing, is replaced by a structured packing. The advantage of this measure consists in that such packings, after having been removed from the tubes from below, also can again be introduced into the tubes from below, so that the catalyst material can remain in its place.

The catalyst bed and the structured packing are held in their position by a gas-permeable, removable holder which each is installed at their lower end. The upper opening of the tubes also can be provided with a gas-permeable closure.

With the tubular reactor according to the invention an apparatus surprisingly has been found, which significantly reduces downtimes and maintenance effort as well as the times and costs related therewith.

In a particular aspect of the invention the reaction zone is divided into a plurality of succeeding sections, wherein on the tube side the kind and quantity of the catalyst material can be varied from section to section and wherein on the shell side each section is equipped with a separately adjustable heating system. This equipment of the tube bundle reactor provides for selectively influencing the course of the reaction.

In a further, particular aspect of the invention the structured packing is split into several parts along its longitudinal axis.

These parts are pushed into the respective tube from below one after the other, whereupon a gas-permeable holder or a gas-permeable tube closure is installed below the last part of the packing, in order to prevent the packings from slipping out.

The division of the packings has the advantage that the packings can be handled more easily in the narrow gas collecting space.

The invention furthermore relates to a method for replacing the structured packing in the cooling zone of a tubular reactor; it comprises the following working steps:
a) shutdown of the tubular reactor,
b) optionally cooling and/or inerting the tubular reactor,
c) opening the access to the cooling zone on the bottom side of the tubular reactor,
d) removal of the structured packing,
e) inserting a new structured packing or the cleaned original packing,
f) closing the access to the cooling zone on the bottom side of the tubular reactor,
g) recommissioning of the tubular reactor.

The tubular reactor according to the invention advantageously can be employed for a multitude of heterogeneously catalyzed reactions, wherein its use for carrying out selective oxidation reactions is particularly preferred. Examples for such reactions include the conversion of propylene to acrolein and/or acrylic acid, the conversion of o-xylene to phthalic anhydride or the conversion of p-xylene to terephthalic acid. In such reactions, intermediate products, e.g. underoxidation products or secondary products, often escape, which are undesired in the reactor product and therefore are deposited in the cooling zone. For example, in the oxidation of o-xylene to phthalic anhydride the undesired intermediate product phthalide is obtained. In the conversion of propylene to acrolein and/or acrylic acid, however, the undesired further reaction of the target products to polymers as secondary products can occur.

Further developments, advantages and possible applications of the invention can also be taken from the following description of exemplary embodiments and the drawings. All features described and/or illustrated form the invention per se or in any combination, independent of their inclusion in the claims or their back-reference.

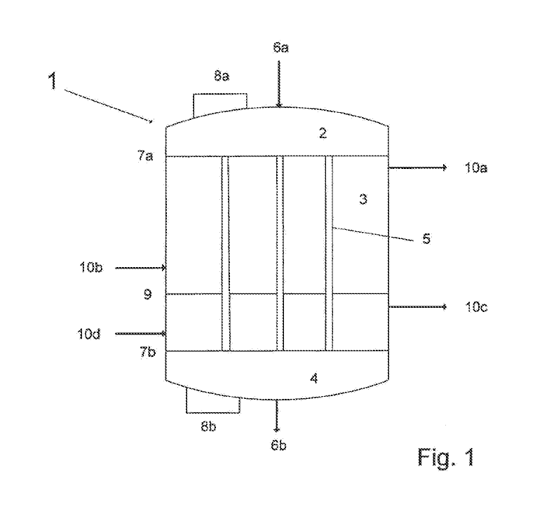

By way of example, FIG. 1 shows an upright tubular reactor (1) with three reactor tubes (5). It substantially consists of an upper gas distributor space (2), a shell space (3), a lower gas collecting space (4) and the tubes (5) of the tube bundle. The gas distributor space (2) and the gas collecting space (4) each are separated from the shell space (3) by a tube plate (7a, b). The gas distributor space (2) is equipped with a port (6a) as inlet for the gas and a hand- or manhole (8a). Through the hand- or manhole (8a) an access is created, in order to fill the tubes (5) with catalyst material.

The gas collecting space (4) likewise is equipped with a port (6b), as outlet for the gas, and a hand- or manhole (8b). Here, the hand- or manhole (8b) provides an access, in order to replace the structured packings in the tubes. By a partition (9), the shell space (3) is divided into an upper reaction zone and a lower cooling zone. The ports (10a, b, c, d) serve as inlets and outlets for the liquid heat-transfer medium.

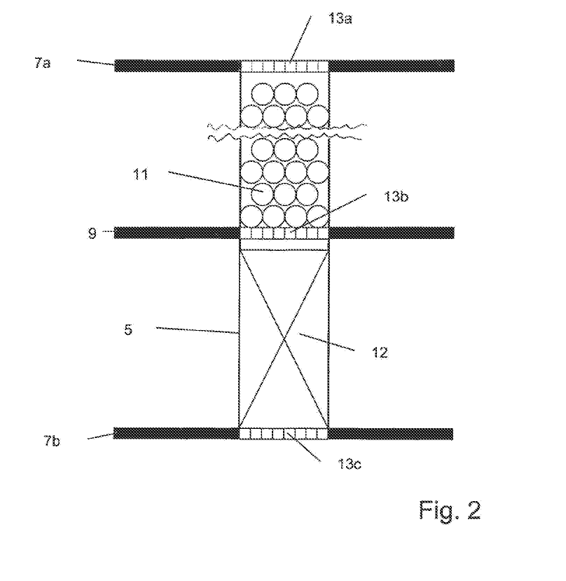

FIG. 2 shows a longitudinal section through a reactor tube (5) of the tube bundle. The reactor tube (5) extends from the upper tube plate (7a), through the partition (9), which separates the reaction zone from the cooling zone of the reactor, to the lower tube plate (7b). In the reaction zone, the tube is filled with a bed of catalyst material (11). In the cooling zone, the tube is filled with a structured packing (12). At the upper and lower opening of the reactor tube (5) and below the catalyst bed, a gas-permeable, removable holder (13a, b, c) each is installed. The same can be designed for example as perforated plates, perforated sheetings, grids or sieve plates.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the attached claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise.

### LIST OF REFERENCE NUMERALS

(1) tubular reactor
(2) gas distributor space
(3) shell space
(4) gas collecting space
(5) reactor tube
(6a,b) ports for gas inlet and outlet
(7a,b) tube plate
(8a,b) hand- or manhole
(9) partition
(10a,b,c,d) inlets and outlets for liquid heat-transfer medium
(11) catalyst material
(12) structured packing (13a,b,c) holder

1: A tubular reactor for carrying out a heterogeneously catalyzed gas phase reaction, the tubular reactor comprising:
a plurality of reactor tubes including a reaction zone and a cooling zone,
wherein the reactor tubes are arranged vertically upright,
wherein the tubular reactor is configured such that a gaseous reaction mixture flows through the reactor tubes from top to bottom and, in doing so, passes first through the reaction zone and then through the cooling zone,
wherein, in an upper part of the reactor tubes, extending in a reaction zone of the tubular reactor, the reactor tubes are filled with a catalyst bed of solid, granular catalyst,
wherein, in a lower part of the reactor tubes, corresponding to the cooling zone of the reactor, the reactor tubes are filled with a structured packing,
wherein the catalyst bed and the structured packing each are held in their position by a gas-permeable, removable holder, and
wherein the reactor tubes are heated in endothermic reactions, and cooled in exothermic reactions, by indirect heat exchange with a heat-transfer medium in the reaction zone, and are cooled in the cooling zone of the reactor.

2: The tubular reactor of claim 1, wherein the reaction zone of the reactor is divided into a plurality of succeeding sections,
wherein on a tube side the kind and quantity of the catalyst material varies from section to section, and
wherein on a shell side each section is equipped with a separately adjustable heat transfer system.

3: The tubular reactor of claim 1, wherein the structured packing is split into several parts along its longitudinal axis.

4: A method for replacing the structured packing in a cooling zone of a tubular reactor of claim 1, the method comprising:
a) shutting down the tubular reactor;
b) opening an access to the cooling zone of the reactor on a bottom side of the tubular reactor;
c) removing the structured packing;
d) inserting a new structured packing or a cleaned original packing;
e) closing the access to the cooling zone of the reactor on the bottom side of the tubular reactor; and
f) recommissioning the tubular reactor.

5: A method of carrying out a selective oxidation reaction, the method comprising:
introducing a compound into the tubular reactor of claim 1.

6: The method of claim 5, wherein the selective oxidation reaction is the conversion of propylene to
acrolein,
acrylic acid, or
acrolein and acrylic acid.

7: The method of claim 5, wherein the selective oxidation reaction is the conversion of o-xylene to phthalic anhydride.

8: The method of claim 5, wherein the selective oxidation reaction is the conversion of p-xylene to terephthalic acid.

9: The method of claim 5, further comprising cooling, inserting, or cooling and inserting the tubular reactor.

10: The tubular reactor of claim 2, wherein the structured packing is split into several parts along its longitudinal axis.
